(19) United States
(12) Patent Application Publication
(10) Pub. No.: US 2010/0066905 A1
(43) Pub. Date: Mar. 18, 2010

(54) SYSTEM, METHOD AND DEVICE FOR DISPLAYING VIDEO SIGNALS

(75) Inventor: Avishay Ben Natan, Rishon LeZion (IL)

Correspondence Address: BROWDY AND NEIMARK, P.L.L.C.;624 NINTH STREET, NW, SUITE 300, WASHINGTON, DC, 20001-5303, US

(73) Assignee: C-NARIO Ltd., Tel-Aviv (IL)

(21) Appl. No.: 12/595,101

(22) PCT Filed: Apr. 7, 2008
(86) PCT No.: PCT/IL08/00479

§ 371 Date: Oct. 8, 2009

(30) Foreign Application Priority Data
Apr. 10, 2007 (IL) 182391

(51) Int. Cl. H04N 7/00; H04N 5/66

(52) U.S. Cl. 348/473; 348/739; 348/E07.001

(57) ABSTRACT

A video displaying system is provided which comprises: display means for displaying an output that is comprised of a plurality of displaying zones, means for providing information conveying tracks and for utilizing information conveyed along these tracks for creating the displayed output, and means operative to synchronize the information conveying tracks. Each of the information conveying tracks of the video displaying system is associated with at least one displaying zone and at least one of the information conveying tracks is associated with at least two displaying zones.

### FIELD OF THE INVENTION

The present invention relates to signage systems. In particularly it concerns method and devices for applying timeline technique in signage systems.

### BACKGROUND OF THE INVENTION

The timeline user interface is used nowadays in a large variety of content creation tools. It is used in audio editing tools to describe relationship in time between various media tracks as well as possible processing that would apply to them along with time.

US 2006224940 describes a method and apparatus for editing video sequences. The method includes providing a display with a plurality of audio/visual sequences where each audio/visual sequence of this plurality of sequences is displayed as a timeline parallel to a first axis and where each position along the timeline corresponds to a temporal location of audio/visual information within the sequence. The plurality of audio/visual sequences overlap along the first axis, providing a scrubhead line that extends across the plurality of timelines and adapted to be moved relative to the timelines of the plurality of sequences while simultaneously displaying audio/visual information from each of the sequences within a respective window of the sequences where the displayed information corresponds to a location of the scrubhead line along the respective timeline of the sequences.

US 2006222320 describes a sequence of video images that can be represented by using multiple related timelines by generating a first timeline identifying a decode order associated with a sequence of video images and a second timeline identifying a display order associated with the sequence of video images. The first and second timelines can be correlated based on an offset, which represents a time period by which decoding precedes the display. The sequence of video images can then be played in accordance with the two correlated timelines.

Still, in video editing software, the product of the various types of the processing procedure is a rectangle representing the viewed area, typically, the TV screen. This rectangular may have higher resolution for high definition editing or ultra high resolution for multi-display presentations. The timeline illustrated in FIG. 1 is an example of a standard video editing timeline known in the art. As may be seen from this Fig., in this implementation, tracks are vertically stacked, so that higher tracks (like the one designated in FIG. 1 as “Upper”) are closer to the viewer. If no processing (digital effect) is applied to an upper track, all other tracks are obscured by this upper one. However, if the upper track is subjected to digital effect such as resizing or transparency change, lower tracks of deeper located layers that are further away from the viewer, may be revealed.

In systems that are used as full real time systems, playback of the timeline results in a processed display, being a rectangle that is consisted. of all tracks after applying the appropriate processing thereto.

If the system cannot perform the processing in real time, a rendering process creates a video file which has horizontal and vertical resolutions, and which will be used at the appropriate time.

When considering signage systems, there are two main approaches for digital signage displays. The first can be related to as page based approached. By this approach, the whole page is created synchronously and used to display whatever information the signage system needs to display.

The second approach can be related to as a zone based approach. By this approach, the display area is divided into zones (each one is of a rectangle shape) and different content may be displayed in each of the zones.

In addition, some of the systems may support overlapping zones, while other systems support non-overlapped zones.

As an example of a zone based system, let us consider FIG. 2 which illustrates a video rectangle (20) displaying a list of pre-edited advertisements, a ticker (22) running underneath with real-time news information and perhaps a logo (24) of the hosting organization placed on the upper left corner of the video. Now, let us assume that this system is operative using overlapping zones. Zone 24 (the logo) is super imposed over zone 20. In some cases, one of the logo colors may be transparent while other are opaque, in a different implementation the logo file has transparency information (usually 256 possible values) for every pixel of the rectangle creating a much better looking logo over the video.

In addition, it should be noted that in the prior art systems, content running in any of the three zones is typically not time-wise associated to the content of any other zone, so that the system is considered to be asynchronous and the zones are respectively asynchronous to each other.

However, the standard video-editing paradigm discussed above is not enough to satisfy the requirements of advanced multi-zone multi-display signage systems.

### SUMMARY OF THE INVENTION

It is an object of the present invention to allow the users to utilize efficiently resources of a multi display video system.

It is another object of the present invention to provide means and method for associating information conveyed in a channel associated with one of the displaying zones, with another displaying zone.

Other objects of the invention will become apparent as the description of the invention proceeds.

Thus, according with a first embodiment of the present invention there is provided a video displaying system, comprising:

one or more display means for displaying an output comprising a plurality of displaying zones;

means for providing information conveying tracks;

means for utilizing information conveyed by these tracks in order to create the displayed output; and

means operative to synchronize the information retrieved from the information conveying tracks,

wherein the system is characterized in that each of the information conveying tracks is associated with at least one displaying zone (e.g. parent displaying zone) and at least one of the information conveying tracks is associated with at least one additional displaying zone (e.g. auxiliary displaying zone).

As should be appreciated by those skilled in the art, the use of the term “displaying zones” may refer to a single device with a plurality of displaying zones, it may refer to a plurality of displaying zones, each being displayed by a different display device, it may refer to zones that are arbitrarily created each across a plurality of display devices while utilizing part of the display area of the respective display zones, and/or any combination thereof. All these options should be understood to be encompassed by the present invention.

According to a preferred embodiment of the invention, the association of that at least one information conveying track with the at least one additional displaying zone, occurs on a temporary basis, e.g. during a displaying session.

In accordance with another preferred embodiment, the association of a track and the corresponding additional displaying zone is determined based on information retrieved from that track.

By yet another embodiment of the invention, the displayed output of the at least one additional displaying zone is only partially dependent on information derived from the at least one of the information conveying tracks associated therewith. Preferably, the partial dependency is such that only part of the displayed output that is generated at that displaying zone will be affected by information conveyed along that track, so that the remaining of that displaying zone is generated based on information retrieved from other track (e.g. the one or more tracks for which this zone is the parent displaying zone).

According to still another embodiment of the invention, the determination of the at least one additional displaying zone associated with the respective information conveying track is made while the output derived from the information conveyed in that track is displayed at the at least one displaying zone associated with that track.

In accordance with another preferred embodiment, output to be displayed in the at least one additional displaying zone and which is derived from information conveyed in the corresponding track, obscures the output to be displayed which is based on information retrieved from any other track associated with that displaying zone.

According to still another embodiment, the system provided further comprising means operative to assign priority either to the information conveyed in the information conveying tracks, or to the tracks themselves, or to a combination thereof. According to this embodiment, preferably, when there is case of a conflict as to what information should be used in order to generate the output display of a certain displaying zone, e.g. when conflicting information for a specific displaying zone is derived from at least two different information conveying tracks, the display output will be formed based on the priority assigned to the conflicting tracks, or to the priority assigned to the information carried along these tracks or to a combination of priorities assigned to both the tracks and the information conveyed thereby.

According to another aspect of the present invention, there is provided a computer-readable medium comprising instructions that perform a timeline editing method for use in a video displaying system, when executed by a processor, is operative to associate each of a plurality of information conveying tracks with at least one displaying zone, wherein at least one of the information conveying tracks is further associated with at least one additional displaying zone, and wherein the method is carried out by defining sequences of information and their respective target information conveying tracks.

Other features described above may also be implemented in different modules (or any combination thereof):
Layout definition software for the definition of zones; and
Playback engine for simultaneous playback of several sequences at the same time on different zones.

According to another aspect of the invention, there is provided a method for use in a video displaying system, comprising:

providing information conveying tracks;

associating each the information conveying tracks with at least one displaying zone, wherein at least one of the information conveying tracks is associated with at least one additional displaying zone;

synchronizing the information conveying tracks;

processing information conveyed in the tracks to create outputs for a plurality of displaying zones;

displaying an output constructed out of a combination of the outputs retrieved from the plurality of displaying zones.

In accordance with an embodiment of this aspect of the invention, the step of associating at least one of the information conveying tracks with at least one additional displaying zone is made on a temporary basis, preferably based on information retrieved from said at least one of said information conveying tracks.

By yet another embodiment of this aspect of the invention, the displayed output of the at least one additional displaying zone is only partially dependent on information derived from the information conveying track associated with that additional displaying zone(s).

### BRIEF DESCRIPTION OF THE DRAWINGS

FIG. 1—presents a standard video editing timeline as used in prior art systems;

FIG. 2—presents an example of a prior art display divided into a number of displaying zones;

FIG. 3A—illustrates an example of nine displays forming a video wall;

FIG. 3B—illustrates the video wall presented in FIG. 3A divided into different display zones;

FIG. 4—presents timeline established for different displaying zones; and

FIG. 5—illustrates an example by which several tracks are associated with each display zone.

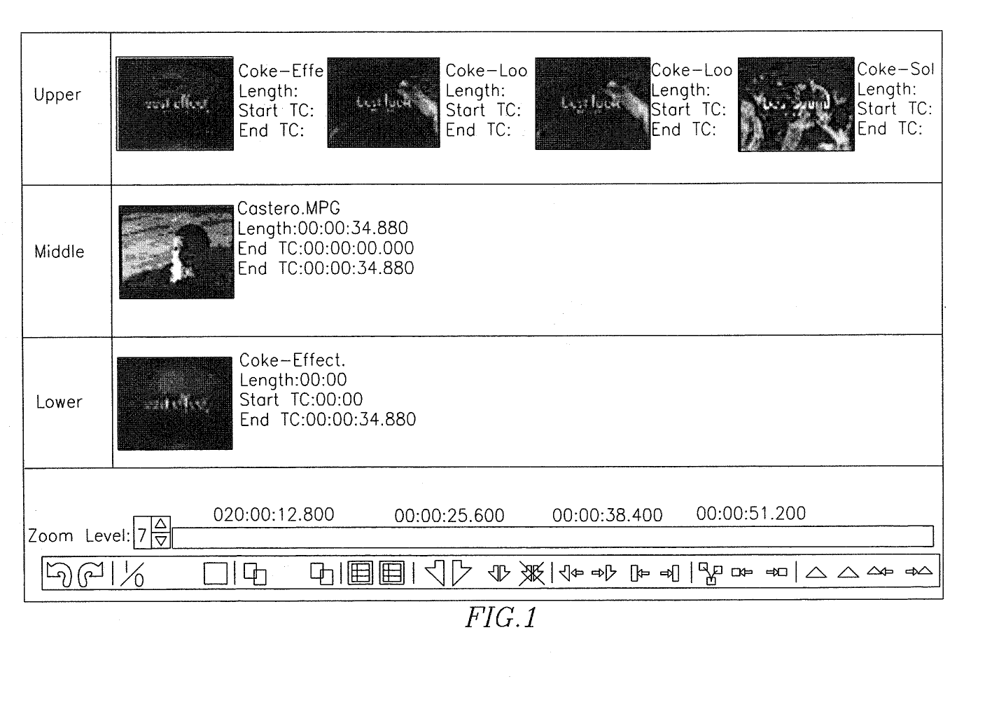

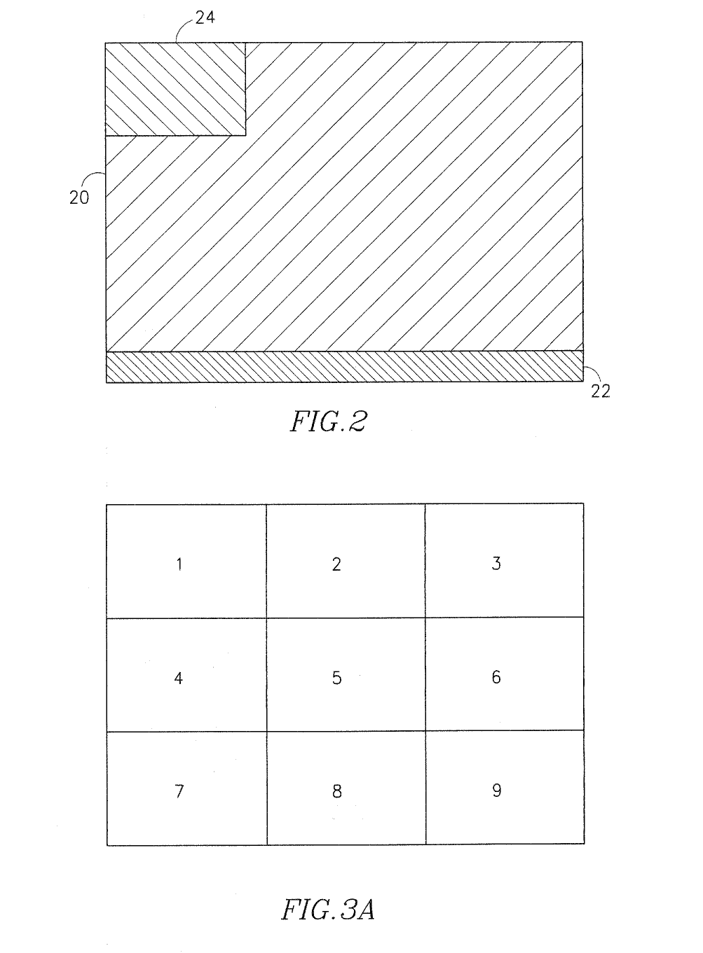

### DETAILED DESCRIPTION OF THE INVENTION

A better understanding of the present invention is obtained when the following non-limiting detailed description is considered in conjunction with the following drawings.

As will be appreciated by those skilled in the art, one of the objects of the method provided by the present invention is to expand the timeline workflow to address special requirements of modern signage system.

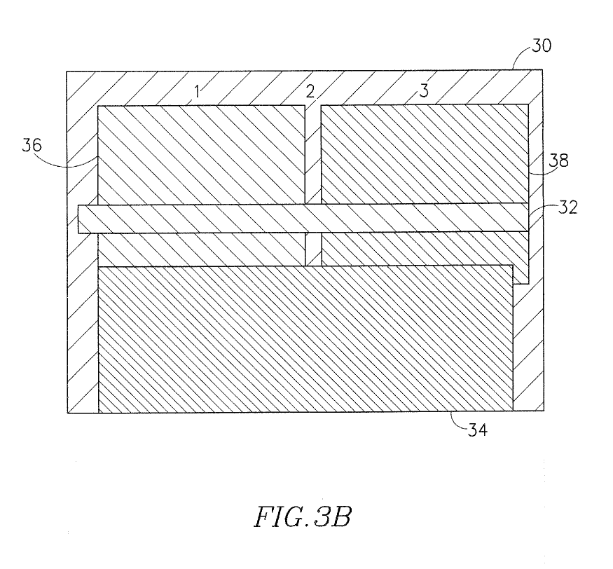

FIGS. 3A and 3B illustrate a collection of zones across several display devices (a video wall). Although the system is described in the example as a system operative on multiple displays, it also applies to the single display case, mutates mutandis. The display illustrated in FIG. 3A consists of 9 video displays. In FIG. 3B the same 9 displays video wall are shown to comprise in fact 5 zones (30, 32, 34, 36 and 38). Apart from size and location, zones have depth property, as seen from the image—zone 30 is the deepest while zones 32 and 34 are the shallowest.

Now, let us consider possible methods for using zones in signage systems. One such method relies on using independent zones. This is the most common way of using zones in signage applications, where a media item can be edited in an external editing software application which creates a rendered file. In the independent zones, media items may be composed in real time in some of the zones, i.e. sub-titles that are super-imposed over a video file. In this case a timeline can be used for describing the temporal relationship between the video file and the sub-titles. This usage is not different from the normal video editing workflow, as the output is targeted into a rectangle, that is, one single zone.

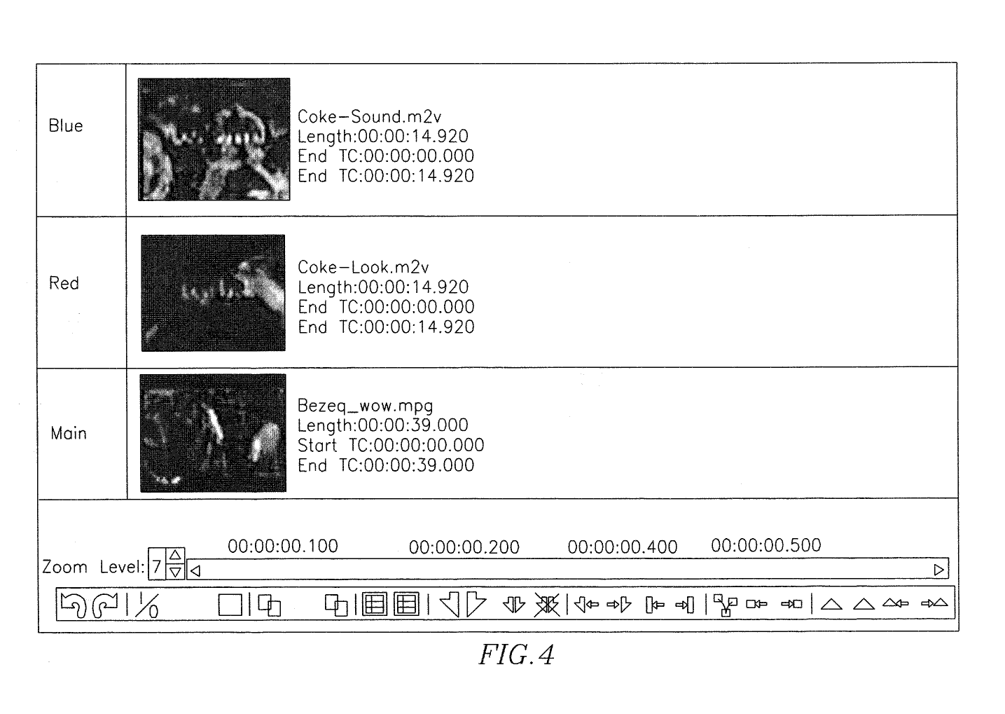

According to an embodiment of the present invention, there is provided a system comprising a plurality of display zones, a system which is characterized by having inter-zone synchronization. Let us consider a system for producing the display depicted in FIG. 4, constructed based on a timeline associated with different zones. In the timeline illustrated by this Fig., there are three tracks, replacing the typical prior art combined output created for a rectangle. The timeline in this Fig. is defined to be played on the three different zones:
The lower track, designated as “Main” will be displayed in whatever zone this sequence/timeline is associated with (the parent zone).
The #Red track will “search” for a zone named Red and the track content will be displayed thereat.
Similarly, the #Blue track will “search” for a zone named Blue and the track content will be displayed thereat.

Consequently, such a timeline can address different zones at the same time which in turn expands the usual video editing timeline.

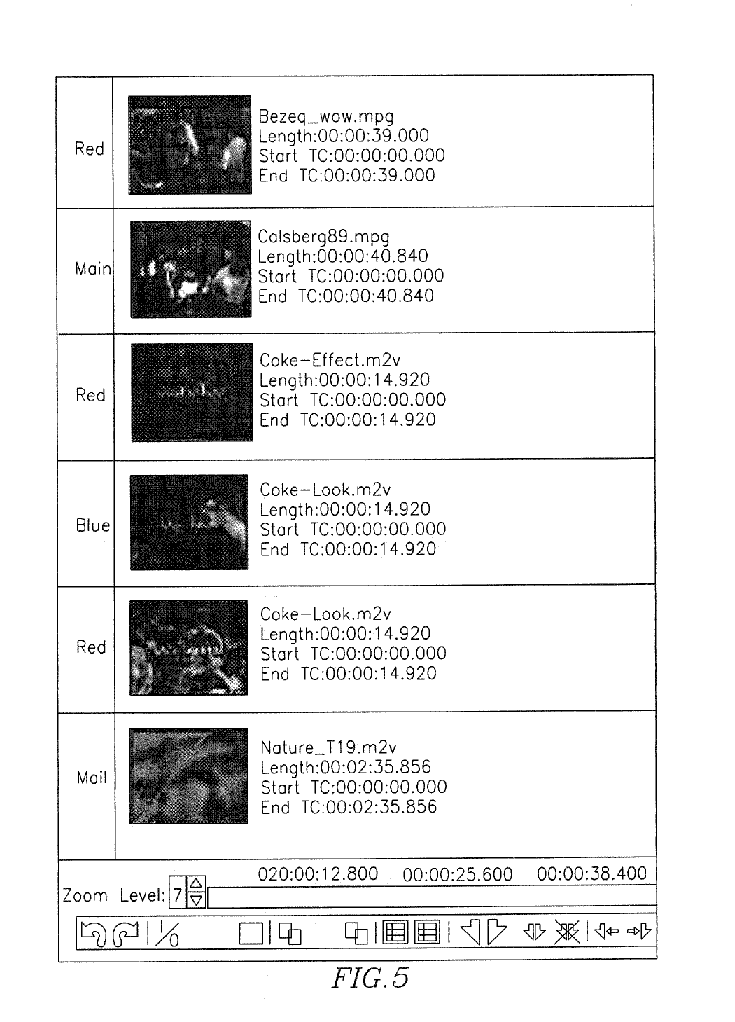

Now let us consider yet another embodiment of the invention, as shown in FIG. 5, where several tracks are associated with one or more of the zones. Preferably, the precedence described above would also apply for the tracks that are associated with the same zone. Therefore, the upper #Red track will obscure the two lower #Red tracks. Original size and alpha channel as well as digital effects applied to upper, closer tracks media may be used for revealing lower, further away tracks. The term “alpha channel” as used herein, is used to denote a method where a separate value is assigned to each pixel in an image or video, in order to describe its transparency value. Typical value range is 256. If a video file has alpha channel, it would have a separate transparency value for each pixel per frame, and this in turn may be described in a synchronized file or embedded inside the file.

All non-designated tracks will be composed into the main zone, that is, the zone associated with this timeline/sequence, where a sequence is the media object that the time line creates.

At any given moment, several zones can asynchronously display sequences, some of which may be confined to their parent zone while other sequences may span across several zones.

In addition, the present invention provides a solution for handling certain special cases:
Display zones can be found while sequence is being played inside the parent zone:
The following rules are preferably applied for the above case:
   Orphaned tracks, having no matching zones, will be simply ignored and not used (displayed).
   Orphaned tracks are played in accordance with their depth as defined for the main, parent display zone.
Target display zones need not to be empty or dormant when sequences need to insert media into them. If other media is being played at the same display zone at the same time, the system can behave according to the following definitions:
   Tracks are assigned with a priority attribute, if two tracks from different sequences collide on a display zone, the higher priority track media shall be displayed closer to the viewer and may obscure lower priority tracks media dependent on original size, sizing options, digital effects and media alpha channel. If the two tracks have identical priority, the resulted output might be un-defined, unless a pre-defined criterion has been implemented to address this scenario.
   Tracks with higher priority may render lower priority tracks media as invisible.

As will be appreciated by those skilled, in the art, the examples provided show different ways of displaying information in signage systems. However, similar processes may be applied in a similar way in order to provide the display media in multi displaying zones systems, without departing from the scope of the present invention.

It is to be understood that the above description only includes some embodiments of the invention and serves for its illustration. Numerous other ways of carrying out the methods provided by the present invention may be devised by a person skilled in the art without departing from the scope of the invention, and are thus encompassed by the present invention.

1. A video displaying system, comprising at least one display means for displaying a displayed output comprising a plurality of displaying zones, and means for providing information conveying tracks and for utilizing information conveyed along said tracks in creating said displayed output, and means operative to synchronize said information conveying tracks, wherein said system is characterized in that each of said information conveying tracks is associated with at least one displaying zone and at least one of said information conveying tracks is associated with at least one additional displaying zone.

2. A system according to claim 1, wherein the association of said at least one of said information conveying tracks with the at least one additional displaying zone, occurs on a temporary basis.

3. A system according to claim 2, wherein said association is determined based on information retrieved from said at least one of said information conveying tracks.

4. A system according to claim 1, wherein the displayed output of said at least one additional displaying zone is only partially dependent on information derived from the at least one of said information conveying tracks associated therewith.

5. A system according to claim 4, wherein the partial dependency is that only part of the displayed output generated at that displaying zone is affected by information conveyed along that track.

6. A system according to claim 1, wherein the determination of said at least one additional displaying zone associated with said information conveying track is made while displaying output derived from information conveyed in said track at the at least one displaying zone associated with that track.

7. A system according to claim 1, wherein output to be displayed in the at least one additional displaying zone which would be derived from information conveyed in said track, obscures the output to be displayed which is based on information retrieved from any other track associated with that displaying zone.

8. A system according to claim 1, further comprising means operative to assign priority to the information conveyed in said information conveying tracks.

9. A system according to claim 8, wherein in case a conflict occurs while determining the output display of a displaying zone as it should be derived from at least two different information conveying tracks, the display output shall be formed based on the priority assigned to each of the conflicting tracks.

10. A method for use in a video displaying system, comprising:
providing information conveying tracks;
associating each of said information conveying tracks with at least one displaying zone, wherein at least one of said information conveying tracks is associated with at least one additional displaying zone;
synchronizing said information conveying tracks;
processing information conveyed in said tracks to create outputs for a plurality of displaying zones;
displaying an output constructed out of a combination of outputs retrieved from said plurality of displaying zones.

11. A method according to claim 10, wherein the step of associating at least one of said information conveying tracks with at least one additional displaying zone is made on a temporary basis.

12. A method according to claim 11, wherein said step of association is determined based on information retrieved from said at least one of said information conveying tracks.

13. A method according to claim 10, wherein the displayed output of said at least one additional displaying zone is only partially dependent on information derived from the information conveying track associated therewith.

14. A computer-readable medium comprising instructions that perform a timeline editing method for use in a video displaying system, when executed by a processor, is operative to associate each of a plurality of information conveying tracks with at least one displaying zone, wherein at least one of said information conveying tracks is further associated with at least one additional displaying zone by defining sequences of information and their respective target information conveying tracks.
